(19) United States
(12) Patent Application Publication
(10) Pub. No.: US 2025/0300277 A1
(43) Pub. Date: Sep. 25, 2025

(54) POWER STORAGE DEVICE

(71) Applicant: TOYOTA JIDOSHA KABUSHIKI KAISHA, Toyota-shi (JP)

(72) Inventors: Shintaro UTSUMI, Susono-shi (JP); Takeru HARA, Toyota-shi (JP); Masataka OGUSHI, Nisshin-shi (JP); Yuji NISHI, Nagoya-shi (JP); Naofumi NOMURA, Nagakute-shi (JP); Nariaki MIKI, Okazaki-shi (JP); Kenta KIMURA, Toyota-shi (JP)

(73) Assignee: TOYOTA JIDOSHA KABUSHIKI KAISHA, Toyota-shi (JP)

(21) Appl. No.: 19/005,610

(22) Filed: Dec. 30, 2024

(30) Foreign Application Priority Data
Mar. 19, 2024 (JP) 2024-043045

(51) Int. Cl. H01M 10/658; H01M 10/613; H01M 10/647; H01M 10/653; H01M 10/6554; H01M 50/209; H01M 50/30

(52) U.S. Cl. CPC H01M 10/658; H01M 10/613; H01M 10/647; H01M 10/653; H01M 10/6554; H01M 50/209; H01M 50/30; H01M 2200/20; H01M 2220/20

(57) ABSTRACT

The power storage device includes a power storage module including a power storage cell, a cooler disposed above the power storage module, and a thermally insulating member. The power storage cell has a short side surface and a short side surface, a positive electrode terminal disposed on the short side surface, and a negative electrode terminal disposed on the short side surface. The thermally insulating member is provided below the cooler and above each of the positive electrode terminal and the negative electrode terminal.

### CROSS-REFERENCE TO RELATED APPLICATION

This application claims priority to Japanese Patent Application No. 2024-043045 filed on Mar. 19, 2024, incorporated herein by reference in its entirety.

### BACKGROUND

### 1. Technical Field

The present disclosure relates to a power storage device.

### 2. Description of Related Art

Japanese Unexamined Patent Application Publication (Translation of PCT Application) No. 2023-529400 (JP 2023-529400 A) discloses a battery pack including a plurality of unit cells, a tray, a vapor chamber, and a cooling pipe. The unit cells are accommodated in an accommodation space of the tray. The vapor chamber covers an upper opening of the accommodation space of the tray. The cooling pipe is disposed on an outer face (a face opposite to the accommodation space) of the vapor chamber.

### SUMMARY

Although not described in JP 2023-529400 A, there are cases in which an electrode terminal is provided on side faces of power storage cells. In this case, it is conceivable that condensation water generated at the vapor chamber (cooler) will drip, and the condensation water will adhere to the electrode terminal.

The present disclosure has been made in order to solve the above problem, and an object thereof is to provide a power storage device that is capable of suppressing dripping of condensation water from a cooler to an electrode terminal provided in a power storage cell.

A power storage device according to a first aspect of the present disclosure includes
a power storage module including at least one power storage cell,
a cooler that is disposed upward from the power storage module, and
a disposed member that is disposed downward from the cooler.

The disposed member is a thermally insulating member.

The at least one power storage cell includes
an upper face,
a lower face,
a side face that is disposed between the upper face and the lower face, and
an electrode terminal that is disposed on the side face.

The thermally insulating member is provided downward from the cooler and also upward from the electrode terminal.

In the power storage device according to the first aspect of the present disclosure, as described above, the thermally insulating member is provided downward from the cooler and also upward from the electrode terminal. Thus, the thermally insulating member is provided between the cooler and the electrode terminal, and accordingly the thermally insulating member can suppress condensation water from the cooler from dripping onto the electrode terminal.

Also, the thermally insulating member can suppress the electrode terminals from being excessively cooled by the cooler.

A power storage device according to a second aspect of the present disclosure includes
a power storage module including at least one power storage cell,
a cooler that is disposed upward from the power storage module, and
a disposed member that is disposed downward from the cooler.

The disposed member is a filling member.

The at least one power storage cell includes
an upper face,
a lower face,
a side face that is disposed between the upper face and the lower face, and
an electrode terminal that is disposed on the side face.

The filling member is filled in a space downward from the cooler and also upward from the electrode terminal.

Note that “the filling member is filled in a space” means “the filling member fills up the space”.

In the power storage device according to the second aspect of the present disclosure, as described above, the filling member is provided downward from the cooler and also upward from the electrode terminal. Thus, the filling member is provided so as to block off the space between the cooler and the electrode terminal, and accordingly condensation water from the cooler can be suppressed from dripping onto the electrode terminal.

Further, the space upward from the electrode terminal is filled up by the filling member, and accordingly the amount of air existing in the space can be maximally reduced. As a result, condensation water due to the condensation of the air can be maximally suppressed from adhering to the electrode terminal.

The filling member may include a thermally conductive member. With such a configuration, the electrode terminals can be effectively cooled by the cooler through the thermally conductive member.

The at least one power storage cell may include a first power storage cell and a second power storage cell that are disposed adjacent to each other.

The cooler may be disposed spanning the first power storage cell and the second power storage cell, upward from the power storage module.

The electrode terminal may include
a first electrode terminal that is provided on the side face of the first power storage cell that is toward the second power storage cell, and
a second electrode terminal that is provided on the side face of the second power storage cell that is toward the first power storage cell.

The disposed member is provided upward from each of the first electrode terminal and the second electrode terminal.

With such a configuration, the disposed member is disposed so as to block off the first electrode terminal, the second electrode terminal, and the cooler. As a result, condensation water from the cooler can be suppressed from dripping onto the first electrode terminal and the second electrode terminal.

The at least one power storage cell may be equipped with an exhaust valve that is situated downward from the electrode terminal. With such a configuration, a flow of gas (smoke) discharged from the exhaust valve (and discharge of the gas from the exhaust valve) can be suppressed from being impeded by the disposed member, in comparison with a case in which the exhaust valve is situated upward from the electrode terminal (on the disposed member side).

The at least one power storage cell may include a plurality of the power storage cells that is arrayed in an array direction. The disposed member extends in the array direction, so as to span the power storage cells that are arrayed in the array direction. With such a configuration, the disposed member is provided so as to cover the electrode terminals of the respective power storage cells upward, and accordingly condensation water can be suppressed from dripping on the electrode terminals.

According to the present disclosure, condensation water from the cooler can be suppressed from dripping onto the electrode terminal that is provided to the power storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle on which a power storage device according to a first embodiment is mounted;

FIG. 2 is an exploded perspective view illustrating a configuration of the power storage device according to the first embodiment;

FIG. 3 is a perspective view showing a configuration of a power storage cell;

FIG. 4 is a cross-sectional view of the power storage device according to the first embodiment taken along the Y direction;

FIG. 5 is a first view illustrating a cross section of the power storage device according to the first embodiment along the X direction;

FIG. 6 is a second view illustrating a cross section of the power storage device according to the first embodiment along the X direction;

FIG. 7 is a first view illustrating a cross section of the power storage device according to the second embodiment along the X direction;

FIG. 8 is a second view illustrating a cross section of the power storage device according to the second embodiment along the X direction;

FIG. 9 is a cross-sectional view of the power storage device according to the second embodiment taken along the Y-direction; and

FIG. 10 is a cross-sectional view of a power storage device according to a modification of the first embodiment taken along the X direction.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

Hereinafter, embodiments and modifications according to the present disclosure will be described with reference to the drawings. In the following description, the same components and components are denoted by the same reference numerals. The same applies to names and functions thereof. Therefore, a detailed description thereof will not be repeated. It should be noted that the embodiments and the modification examples described below may be selectively combined as appropriate.

### First Embodiment

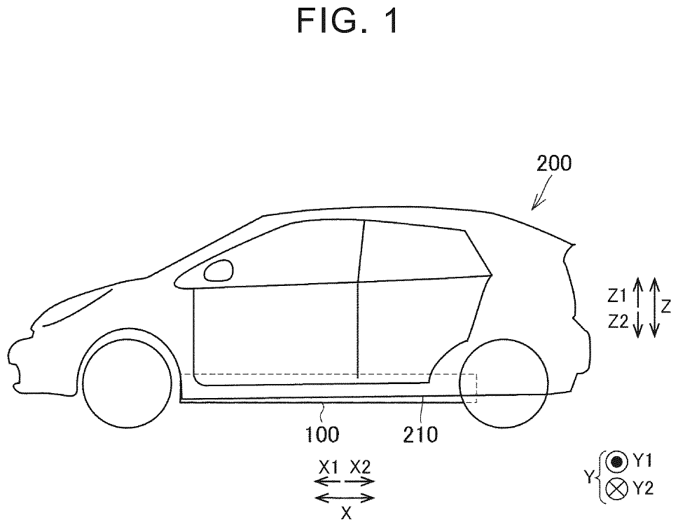

The power storage device 100 according to the first embodiment will be described with reference to FIGS. 1 to 6. FIG. 1 is a side view schematically showing a vehicle 200 including a power storage device 100 according to a first embodiment. Note that the X direction, the Y direction, and the Z direction in this specification are directions orthogonal to each other. For example, the X direction and the Y direction are the front-rear direction and the vehicle width direction of the vehicle 200 when the power storage device 100 is mounted on the vehicle 200, respectively. Further, the Z direction is an up-down (vertical) direction. Note that the Y direction is an example of the “array direction” of the present disclosure.

Referring to FIG. 1, the power storage device 100 is, for example, a device for storing electric power for driving the vehicle 200. The power storage device 100 is disposed on an under body 210 (floor panel) of the vehicle 200. Exemplary vehicles 200 may include hybrid electric vehicle, plug-in hybrid electric vehicle, fuel cell electric vehicle, and battery electric vehicle. Note that the power storage device 100 may be provided in an electric device other than the vehicle (for example, a stationary power storage device).

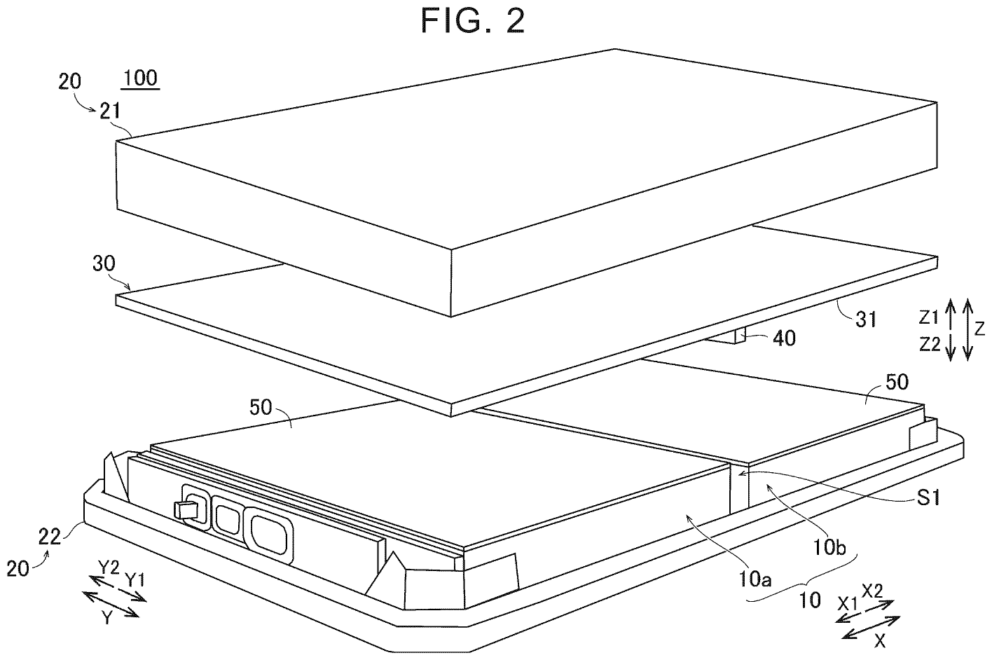

FIG. 2 is an exploded perspective view illustrating a configuration of the power storage device 100 according to the first embodiment. The power storage device 100 includes a power storage module 10, a case 20, a cooler 30, a thermally insulating member 40, and a thermally conductive material 50.

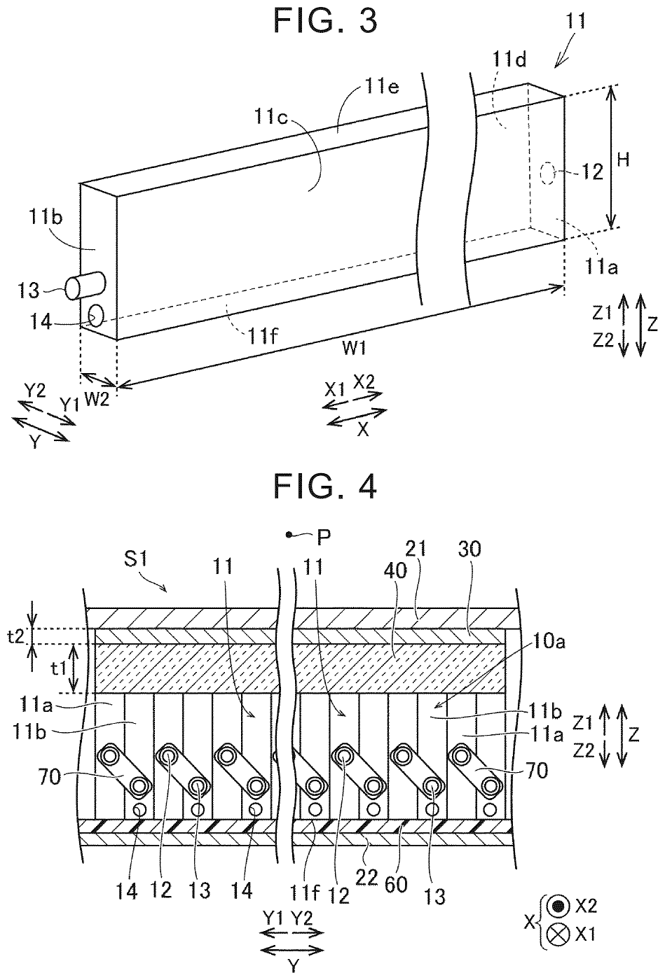

The power storage module 10 includes a cell unit 10a and a cell unit 10b. Each of the cell units 10a and 10b includes a plurality of power storage cells 11 (FIG. 3). The cell unit 10a and the cell unit 10b are provided adjacent to each other in the X-direction. The cell unit 10a is disposed X1 of the cell unit 10b (e.g., in front of the vehicle). A space S1 is formed between the cell unit 10a and the cell unit 10b. The number of cell units may be three or more. Further, the power storage cell 11 of the cell unit 10a is an exemplary “first power storage cell” of the present disclosure. The power storage cell 11 of the cell unit 10b is an exemplary “second power storage cell” of the present disclosure.

The case 20 houses the power storage module 10. The case 20 includes an upper case 21 and a lower case 22. The power storage module 10 is accommodated in a space formed by assembling the upper case 21 to the lower case 22. The cooler 30 is also housed in the case 20.

The cooler 30 is disposed above (Z1 to) the power storage module 10. The cooler 30 is disposed across the cell unit 10a and the cell unit 10b. The cooler 30 is provided so as to cover the cell unit 10a, the cell unit 10b, and the space S1 from Z1. The cooler 30 has a plate-like shape formed so as to extend along XY plane.

The thermally insulating member 40 is disposed below the cooler 30. Specifically, the thermally insulating member 40 is attached to the lower surface 31 of the cooler 30 by an adhesive or the like. The thermally insulating member 40 is disposed in the space S1 when the cooler 30 is placed on the power storage module 10. Examples of the thermally insulating member 40 include a foamed plastic heat insulating material such as extruded polystyrene foam, a fiber-based heat insulating material glass wool such as cellulose fiber, and a natural material-based heat insulating material such as cork carbide. The thermally insulating member 40 has a lower thermal conductivity than the thermally conductive material 50, for example. The thermally insulating member 40 may have a lower thermal conductivity than a metal (iron, aluminum, and the like) forming the case 20, the cooler 30, and the like, for example.

The thermally conductive material 50 is applied to the upper surface 11e (FIG. 3) of each of the plurality of power storage cells 11 (FIG. 3). Thus, the thermally conductive material 50 is provided so as to cover each of the cell unit 10a and 10b from above. That is, the thermally conductive material 50 disposed on the cell unit 10a and the thermally conductive material 50 disposed on the cell unit 10b are provided separately from each other. The thermally conductive material 50 is sandwiched between the cooler 30 and each of the cell units 10a and 10b. The thermally conductive material 50 is formed of, for example, a thermally conductive adhesive material.

FIG. 3 is a perspective view illustrating a configuration of the power storage cell 11. The power storage cell 11 has a short side surface 11a, a short side surface 11b, a long side surface 11c, a long side surface 11d, an upper surface 11e, and a lower surface 11f.

The short side surface 11a and the short side surface 11b are arrayed in the X-direction. Specifically, the short-side surface 11a and the short-side surface 11b are one end surface and the other end surface of the power storage cell 11 in the X-direction, respectively.

The long side surface 11c and the long side surface 11d are arrayed in the Y-direction. Specifically, the long side surface 11c and the long side surface 11d are one end surface and the other end surface of the power storage cell 11 in the Y-direction, respectively.

The upper surface 11e and the lower surface 11f are arrayed in the Z-direction. Specifically, the upper surface 11e and the lower surface 11f are Z1 end surface and Z2 end surface of the power storage cell 11, respectively.

Each of the short side surface 11a, the short side surface 11b, the long side surface 11c, and the long side surface 11d is disposed between the upper surface 11e and the lower surface 11f, and connects the upper surface 11e and the lower surface 11f.

The power storage cell 11 is formed to be long in the X direction. Specifically, the width W1 of the power storage cell 11 in the X direction is larger than the width W2 of the power storage cell 11 in the Y direction. The width W1 is larger than the height H of the power storage cell 11 in the Z-direction. The height H is larger than the width W2.

The power storage cell 11 further includes a positive electrode terminal 12 and a negative electrode terminal 13. The positive electrode terminal 12 is provided on the short side surface 11a. The negative electrode terminal 13 is provided on the short side surface 11b. The positive electrode terminal 12 is provided so as to protrude from the short side surface 11a in the X-direction. The negative electrode terminal 13 is provided so as to protrude from the short side surface 11b in the X-direction. Note that each of the positive electrode terminal 12 and the negative electrode terminal 13 is an example of an “electrode terminal” of the present disclosure.

The power storage cell 11 further includes a cell exhaust valve 14 that exhausts the gas in the power storage cell 11. The cell exhaust valve 14 is configured to discharge the gas (smoke) inside the power storage cell 11 to the outside of the power storage cell 11 when the internal pressure of the power storage cell 11 increases. The cell exhaust valve 14 is provided on the short side surface 11b of the power storage cell 11. The cell exhaust valve 14 is an example of an “exhaust unit” of the present disclosure.

The cell exhaust valve 14 is provided below the negative electrode terminal 13. Specifically, the cell exhaust valve 14 is located in the vicinity of the lower surface 11f of the power storage cell 11. The negative electrode terminal 13 is located below the positive electrode terminal 12. That is, the cell exhaust valve 14 is located below the positive electrode terminal 12.

FIG. 4 is a side view of the cell unit 10a as viewed from X2, and is also a cross-sectional view formed when the space S1 is cut along the Y-direction. The power storage device 100 further includes an adhesive material 60 and a plurality of bus bars 70. The configuration of the cell unit 10b is also the same as that of FIG. 4.

As shown in FIG. 4, the power storage cells 11 disposed so that the short side surface 11a faces X2 side (the space S1 side, the front side of the paper) and the power storage cells 11 disposed so that the short side surface 11b faces X2 side are alternately arrayed in the Y-direction.

As a result, the positive electrode terminal 12 and the negative electrode terminal 13 of the power storage cells 11 adjacent to each other in the Y direction are disposed adjacent to each other. The bus bar 70 connects the positive electrode terminal 12 and the negative electrode terminal 13 adjacent to each other in the Y direction. Further, a plurality of cell exhaust valves 14 are arrayed in the Y direction. Although not shown in the drawings, the plurality of cell exhaust valves 14 are arrayed in the Y-direction also on X1 side (the back side of the drawing).

The adhesive material 60 is provided between the power storage module 10 and the lower case 22. The adhesive material 60 adheres the lower surface 11f of each of the plurality of power storage cells 11 to the lower case 22. Thus, each of the plurality of power storage cells 11 is fixed to the lower case 22.

Here, in the conventional power storage device, it is conceivable that the dew condensation water generated in the cooler is dropped, so that the dew condensation water adheres to the electrode terminal.

Therefore, in the present embodiment, the thermally insulating member 40 is provided below the cooler 30 and above each of the positive electrode terminal 12 and the negative electrode terminal 13. The thermally insulating member 40 is provided at a position overlapping with each of the positive electrode terminal 12 and the negative electrode terminal 13 in the Z direction. Specifically, when the thermally insulating member 40 is viewed from a point P that is Z1 from each of the positive electrode terminal 12 and the negative electrode terminal 13 and the thermally insulating member 40, each of the positive electrode terminal 12 and the negative electrode terminal 13 is covered with the thermally insulating member 40 and is not exposed. The thermally insulating member 40 is an example of a “disposed member” of the present disclosure.

The thermally insulating member 40 is in contact with the cooler 30, while being separated from each of the positive electrode terminal 12 and the negative electrode terminal 13.

The thermally insulating member 40 extends in the Y direction so as to straddle the plurality of power storage cells 11 arrayed in the Y direction. Accordingly, since the thermally insulating member 40 is provided so as to extend in the Y-direction along each of the cell units 10a and 10b, the stiffness of each of the cell units 10a and 10b can be increased. Specifically, the thermally insulating member 40 extends from Y1 end portion to Y2 end portion of each of the cell units 10a and 10b.

The thermally insulating member 40 has a thickness t1 in the Z-direction. The thickness t1 is larger than, for example, the Z-direction thickness t2 of the cooler 30. As a result, the heat insulating property of the thermally insulating member 40 can be ensured as compared with the case where the thickness t1 is equal to or smaller than the thickness t2. As a result, it is possible to suppress the condensation water from being generated due to the cooling of the water in the air in the space S1. In addition, since the thickness t1 of the thermally insulating member 40 is relatively large, the quantity of water drops dropped from the cooler 30 absorbed by the thermally insulating member 40 can be increased.

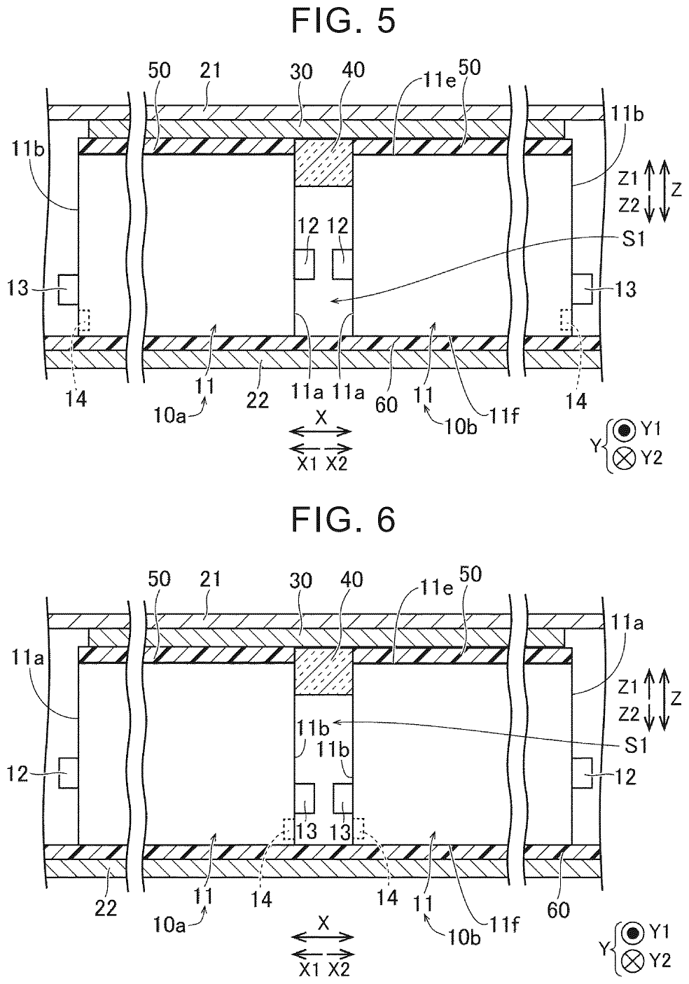

FIG. 5 is a cross-sectional view at a position where the short side surface 11a face each other. In FIG. 5, the power storage cells 11 of each of the cell units 10a and 10b are disposed such that the short side surface 11a faces toward the space S1. Note that the short side surface 11a facing the space S1 is an exemplary “side surface” of the present disclosure. In addition, the positive electrode terminal 12 provided on the short side surface 11a facing the space S1 is an exemplary “electrode terminal” of the present disclosure. Further, the positive electrode terminal 12 provided on the short side surface 11a of the power storage cell 11 of the cell unit 10a toward the space S1 side (the cell unit 10b side) is an exemplary “first electrode terminal” disclosed herein. Further, the positive electrode terminal 12 provided on the short side surface 11a of the power storage cell 11 of the cell unit 10b toward the space S1 side (the cell unit 10a side) is an exemplary “second electrode terminal” disclosed herein.

In FIG. 5, the thermally insulating member 40 is provided above each of the positive electrode terminal 12 on the cell unit 10a side and the positive electrode terminal 12 on the cell unit 10b side. Specifically, the thermally insulating member 40 extends in the X-direction so as to straddle the positive electrode terminal 12 on the cell unit 10a side and the positive electrode terminal 12 on the cell unit 10b side.

In FIG. 5, the thermally insulating member 40 is in close contact with each of the short side surface 11a of the power storage cell 11 on the cell unit 10a side and the short side surface 11a of the power storage cell 11 on the cell unit 10b side. This can suppress a gap from being formed between the short side surface 11a and the thermally insulating member 40. The thermally insulating member 40 is sandwiched between the power storage cells 11 adjacent to each other in the X direction. The thermally insulating member 40 may be an elastic body.

FIG. 6 is a cross-sectional view at a position where the short side surface 11b face each other (for example, a position where the power storage cells 11 adjacent to the power storage cells 11 illustrated in FIG. 5 in the Y-direction are provided). In FIG. 6, the power storage cells 11 of each of the cell units 10a and 10b are disposed such that the short side surface 11b faces toward the space S1. Note that the short side surface 11b facing the space S1 is an exemplary “side surface” of the present disclosure. In addition, the negative electrode terminal 13 provided on the short side surface 11b facing the space S1 is an exemplary “electrode terminal” of the present disclosure. Further, the negative electrode terminal 13 provided on the short side surface 11b of the power storage cell 11 of the cell unit 10a toward the space S1 side (the cell unit 10b side) is an exemplary “first electrode terminal” of the present disclosure. Further, the negative electrode terminal 13 provided on the short side surface 11b of the power storage cell 11 of the cell unit 10b toward the space S1 side (the cell unit 10a side) is an exemplary “second electrode terminal” of the present disclosure.

In FIG. 6, the thermally insulating member 40 extends in the X-direction so as to straddle the negative electrode terminal 13 on the cell unit 10a side and the negative electrode terminal 13 on the cell unit 10b side.

In FIG. 6, the thermally insulating member 40 is in close contact with each of the short side surface 11b of the power storage cell 11 on the cell unit 10a side and the short side surface 11b of the power storage cell 11 on the cell unit 10b side.

Note that the disposing of the power storage cells 11 is not limited to the example illustrated in FIGS. 5 and 6. The short side surface 11a and the short side surface 11b may face each other in the X-direction.

As described above, in the first embodiment, the thermally insulating member 40 is provided below the cooler 30 and above each of the positive electrode terminal 12 and the negative electrode terminal 13. Accordingly, since the thermally insulating member 40 is provided so as to isolate (divide) the cooler 30 from each of the positive electrode terminal 12 and the negative electrode terminal 13, it is possible to suppress (block) the dew condensation water of the cooler 30 from being dropped onto each of the positive electrode terminal 12 and the negative electrode terminal 13.

Further, since the thermally insulating member 40 can suppress the air above the electrode terminals (12, 13) from being cooled by the cooler 30, it is possible to suppress the generation of dew condensation water from the air.

Further, the thermally insulating member 40 is provided above each of the electrode terminals (12, 13) of the cell unit 10a and 10b protruding toward the space S1. Thus, in the configuration in which the cooler 30 is disposed so as to straddle the cell unit 10a and the cell unit 10b, it is possible to easily suppress the condensate from adhering to the electrode terminals (12, 13) disposed in the space S1.

### Second Embodiment

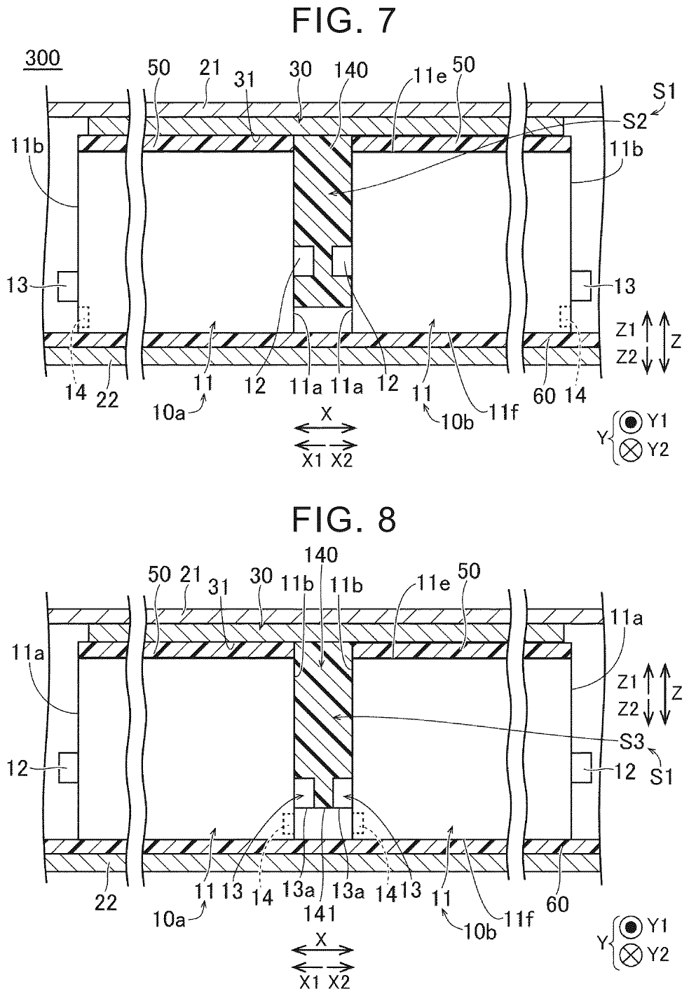

A second embodiment of the present disclosure will be described with reference to FIG. 7 to FIG. 9. In the second embodiment, a thermally conductive member 140 is used instead of the thermally insulating member 40 of the first embodiment. The same components as those in the first embodiment are denoted by the same reference numerals and will not be described repeatedly.

As illustrated in FIG. 7, the power storage device 300 according to the second embodiment includes a thermally conductive member 140. The thermally conductive member 140 may be formed of the same material as the thermally conductive material 50, or may be formed of a material different from the thermally conductive material 50. The thermally conductive member 140 has a higher thermal conductivity than, for example, a metal (iron, aluminum, or the like) forming the case 20, the cooler 30, and the like. The thermally conductive member 140 is formed of, for example, a gel-like thermally conductive material. The thermally conductive member 140 is an example of the “disposed member” and the “filling member” of the present disclosure.

The thermally conductive member 140 is provided above each of the positive electrode terminal 12 on the cell unit 10a side and the positive electrode terminal 12 on the cell unit 10b side. Specifically, the thermally conductive member 140 is filled in the space S2 above the positive electrode terminal 12 in the space S1. In other words, the space S2 is filled with the thermally conductive member 140. Therefore, the thermally conductive member 140 contacts the positive electrode terminal 12 and the short side surface 11a on the cell unit 10a side, the positive electrode terminal 12 and the short side surface 11a on the cell unit 10b side, and the lower surface 31 of the cooler 30.

The thermally conductive member 140 is formed to extend in the Z direction. Specifically, the thermally conductive member 140 extends from the lower surface 31 of the cooler 30 to the lower portion of the positive electrode terminal 12.

As illustrated in FIG. 8, the thermally conductive member 140 is provided above each of the negative electrode terminal 13 on the cell unit 10a side and the negative electrode terminal 13 on the cell unit 10b side. Specifically, the thermally conductive member 140 is filled in the space S3 above the negative electrode terminal 13 in the space S1. In other words, the space S3 is filled with the thermally conductive member 140. Therefore, the thermally conductive member 140 contacts the negative electrode terminal 13 and the short side surface 11b on the cell unit 10a side, the negative electrode terminal 13 and the short side surface 11a on the cell unit 10b side, and the lower surface 31 of the cooler 30.

The thermally conductive member 140 extends from the lower surface 31 of the cooler 30 to the lower end portion 13a of the negative electrode terminal 13. The lower end portion 141 of the thermally conductive member 140 is positioned above the cell exhaust valve 14. The lower end portion 141 of the thermally conductive member 140 may be positioned above or below the lower end portion 13a of the negative electrode terminal 13. Further, the position of the lower end portion 141 of the thermally conductive member 140 in the Z direction may be different for each position in the Y direction (for example, depending on the position of the short side surface 11a and the position of the short side surface 11b).

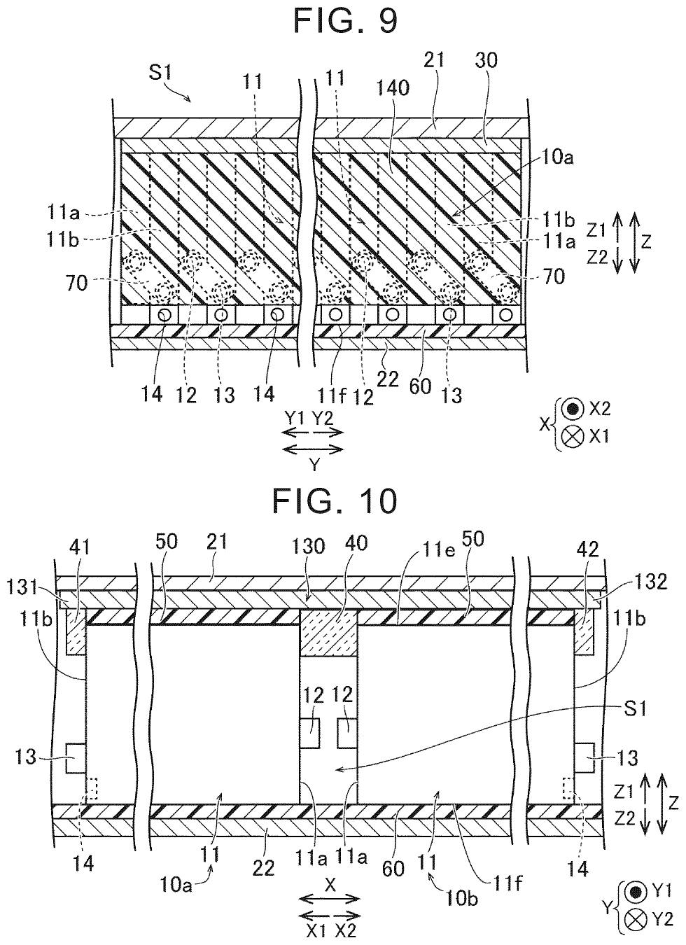

As illustrated in FIG. 9, the thermally conductive member 140 is formed so as to extend in the Y direction so as to straddle the power storage cells 11 arrayed in the Y direction.

Note that the other configurations are the same as those of the first embodiment, and thus the description thereof will not be repeated.

As described above, in the second embodiment, the thermally conductive member 140 is filled in the space (S2, S3) above the electrode terminals (12, 13). Thus, the heat exchange between the cooler 30 and the electrode terminals (12, 13) can be efficiently performed by the thermally conductive member 140.

In addition, since the space (S2, S3) is filled with the thermally conductive member 140, it is possible to suppress the air in the space (S2, S3) from condensing. As a result, adhesion of dew condensation water to the electrode terminals (12, 13) can be further suppressed.

### Modification

In the first embodiment, the thermally insulating member 40 is fixed to the cooler 30, but the present disclosure is not limited thereto. The thermally insulating member 40 may be fixed to a short side surface (11a, 11b), for example.

In the first embodiment, an example in which the thermally insulating member 40 is disposed has been described, but the present disclosure is not limited to this. For example, an insulating filler (e.g., a gel-like insulating material) may be filled in the space between the cooler 30 and the electrode terminals (12, 13). In this case, the heat insulating material is an example of a “filling member” of the present disclosure.

In the second embodiment, an example in which the gel-like thermally conductive member 140 is filled has been described, but the present disclosure is not limited thereto. For example, a sheet-like or block-like thermally conductive member may be disposed in a space between the cooler 30 and the electrode terminals (12, 13).

In the first embodiment, the thermally insulating member 40 is provided between the electrode terminals (12, 13) on the space S1 side and the cooler 30. The disposed position of the thermally insulating member is not limited to the space S1.

For example, as shown in FIG. 10, the thermally insulating member 41 may be provided below X1 protruding portion 131 of the cooler 130. In the embodiment illustrated in FIG. 10, the thermally insulating member 41 is disposed above the electrode terminal (the negative electrode terminal 13 in FIG. 10) provided on the cell unit 10a opposite to the space S1. Further, the thermally insulating member 42 may be provided below X2 protruding portion 132 of the cooler 130. In the embodiment illustrated in FIG. 10, the thermally insulating member 42 is disposed above the electrode terminal (the negative electrode terminal 13 in FIG. 10) provided on the cell unit 10b opposite to the space S1. The protruding portion 131 protrudes X1 from the cell unit 10a. The protrusion 132 protrudes X2 from the cell unit 10b. Note that this modification may also be applied to the second embodiment. Each of the thermally insulating members 41 and 42 is an example of a “disposed member” of the present disclosure.

In the first and second embodiments, an example in which the power storage cells 11 (cell units) are arranged in the X direction has been described, but the present disclosure is not limited to this. The power storage cells 11 (cell units) may not be arranged in the X direction.

In the first and second embodiments, the plurality of power storage cells 11 are arrayed in the Y direction (vehicle width direction), but the present disclosure is not limited thereto. The plurality of power storage cells 11 may be arrayed in the X direction (vehicle front-rear direction).

In the first and second embodiments, the cell exhaust valve 14 is provided on the short side surface 11b of the power storage cell 11, but the present disclosure is not limited thereto. For example, the cell exhaust valve may be provided on the short side surface 11a or the lower surface 11f of the power storage cell 11.

In the first and second embodiments, the positive electrode terminal 12 and the negative electrode terminal 13 are provided on the short side surface 11a and the short side surface 11b, respectively. Each of the positive electrode terminal 12 and the negative electrode terminal 13 may be provided on the short side surface 11a or the short side surface 11b.

In the first and second embodiments described above, the positive electrode terminal 12 and the negative electrode terminal 13 are disposed at different height positions in the Z direction, but the present disclosure is not limited thereto. The positive electrode terminal 12 and the negative electrode terminal 13 may be disposed at the same height position in the Z direction.

Although the cell exhaust valve 14 is positioned below the positive electrode terminal 12 and the negative electrode terminal 13 in the first and second embodiments, the present disclosure is not limited thereto. For example, if all of the cell exhaust valves 14 are provided on the short side surface (11a, 11b) opposite to the space S1, the cell exhaust valve 14 may be positioned at the same Z-direction position as or above the positive electrode terminal 12 or the negative electrode terminal 13.

In the first embodiment, the thermally insulating member 40 extends in the Y-direction so as to straddle the electrode terminals (12, 13) on the cell unit 10a side and the electrode terminals (12, 13) on the cell unit 10b side. The thermally insulating member provided above the electrode terminals (12, 13) on the cell unit 10a side and the thermally insulating member provided above the electrode terminals (12, 13) on the cell unit 10b side may be provided separately. This modification may also be applied to the second embodiment.

In the first embodiment, the thermally insulating member 40 extends in the Y direction so as to straddle the plurality of power storage cells 11 arrayed in the X direction, but the present disclosure is not limited thereto. A plurality of thermally insulating members provided for each power storage cell 11 may be arrayed in the Y direction. This modification may also be applied to the second embodiment.

Note that the configurations (processes) of the above-described embodiments and the above-described modification examples may be combined with each other.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A power storage device, comprising:
a power storage module including at least one power storage cell;
a cooler that is disposed upward from the power storage module; and
a disposed member that is disposed downward from the cooler, wherein
the disposed member is a thermally insulating member,
the at least one power storage cell includes
an upper face,
a lower face,
a side face that is disposed between the upper face and the lower face, and
an electrode terminal that is disposed on the side face, and
the thermally insulating member is provided downward from the cooler and also upward from the electrode terminal.

2. A power storage device, comprising:
a power storage module including at least one power storage cell;
a cooler that is disposed upward from the power storage module; and
a disposed member that is disposed downward from the cooler, wherein
the disposed member is a filling member,
the at least one power storage cell includes
an upper face,
a lower face,
a side face that is disposed between the upper face and the lower face, and
an electrode terminal that is disposed on the side face, and
the filling member is filled in a space downward from the cooler and also upward from the electrode terminal.

3. The power storage device according to claim 2, wherein the filling member includes a thermally conductive member.

4. The power storage device according to claim 1, wherein:
the at least one power storage cell includes a first power storage cell and a second power storage cell that are disposed adjacent to each other;
the cooler is disposed spanning the first power storage cell and the second power storage cell, upward from the power storage module;
the electrode terminal includes
a first electrode terminal that is provided on the side face of the first power storage cell that is toward the second power storage cell, and
a second electrode terminal that is provided on the side face of the second power storage cell that is toward the first power storage cell; and
the disposed member is provided upward from each of the first electrode terminal and the second electrode terminal.

5. The power storage device according to claim 2, wherein:
the at least one power storage cell includes a first power storage cell and a second power storage cell that are disposed adjacent to each other;
the cooler is disposed spanning the first power storage cell and the second power storage cell, upward from the power storage module;
the electrode terminal includes
a first electrode terminal that is provided on the side face of the first power storage cell that is toward the second power storage cell, and
a second electrode terminal that is provided on the side face of the second power storage cell that is toward the first power storage cell; and
the disposed member is provided upward from each of the first electrode terminal and the second electrode terminal.

6. The power storage device according to claim 1, wherein the at least one power storage cell is equipped with an exhaust valve that is situated downward from the electrode terminal.

7. The power storage device according to claim 2, wherein the at least one power storage cell is equipped with an exhaust valve that is situated downward from the electrode terminal.

8. The power storage device according to claim 1, wherein:
the at least one power storage cell includes a plurality of the power storage cells that is arrayed in an array direction; and
the disposed member extends in the array direction, so as to span the power storage cells that are arrayed in the array direction.

9. The power storage device according to any claim 2, wherein:
the at least one power storage cell includes a plurality of the power storage cells that is arrayed in an array direction; and
the disposed member extends in the array direction, so as to span the power storage cells that are arrayed in the array direction.
